(19) United States
(12) Patent Application Publication
(10) Pub. No.: US 2006/0228610 A1
(43) Pub. Date: Oct. 12, 2006

(54) Card-insertion type of fuel cell apparatus

(76) Inventors: Hsi-Ming Shu, Taipei (TW); Weili Huang, Taipei (TW)

Correspondence Address: G. LINK Co., LTD, 3550 Bell Road, MINOOKA, IL, 60447, US

(21) Appl. No.: 11/102,233

(22) Filed: Apr. 11, 2005

(51) Int. Cl. H01M 8/02; H01M 2/10

(52) U.S. Cl. 429/34; 429/96

(57) ABSTRACT

The present invention is related to a card-insertion type of fuel cell apparatus. The substrate is placed at least one membrane electrode assembly, the insertion portion is placed on the bottom of the substrate, and the first fastener is placed on the substrate, wherein the insertion portion and the first fastener are fitted to the fixer for use to possibly fix the card-insertion type of fuel cell apparatus into the fixer. Furthermore, the combination of the insertion portion of the substrate and the slot of the fixer possesses the structural and electrical connections so as to make the membrane electrode assemblies of the fuel cell of the substrate output the electrical power and conduct the control signals to the circuit board.

### FIELD OF THE INVENTION

The present invention is related to a fuel cell apparatus, especially to a card-insertion type of fuel cell apparatus which has a structure to fix into the fixer in order to make the fuel cell apparatus able to assemble in the card-insertion type to form a power supply source.

### BACKGROUND OF THE INVENTION

The conventional fuel cell uses fuel with hydrogen like methanol to form the current loop as the power source by oxidation-reduction reaction. The reactant needed by this kind of fuel cell has liquid fuel like methanol fuel, and the main product after the reaction is water and carbon-dioxide so as to make the fuel cell have the container structure filled with liquid fuel and the mechanism to drive the fuel flow. However, the general fuel cell used in huge power plants is directly designed for the fuel cell to offer specific current and specific voltage so as not to possess circuitry or an assembly structure and fails to form a modularized fuel cell.

Therefore, the present invention is based on the disadvantages of the conventional fuel cell apparatus to invent a card-insertion type of fuel cell apparatus.

### SUMMARY OF THE INVENTION

The first objective of the present invention is to provide a card-insertion type of fuel cell apparatus to make the fuel cell apparatus possibly assemble in the card-insertion type to form a power supply source.

Another objective of the present invention is to provide a card-insertion type of fuel cell apparatus to form a structure for convenient decomposition by the way of the combination of the substrate being placed in the fuel cell and fixer.

The third objective of the present invention is to provide a card-insertion type of fuel cell apparatus to make the fuel cell fixed on the circuit board by the substrate and fixer to also achieve an electrical connection.

To achieve the above objectives, the present invention is a card-insertion type of fuel cell apparatus. The substrate is placed at least one membrane electrode assembly, the insertion portion is placed on the bottom of the substrate, and the first fastener is placed on the substrate, wherein the insertion portion and the first fastener are fitted to the fixer and ensure to fix the card-insertion type of fuel cell apparatus into the fixer. Furthermore, the combination of the insertion portion of the substrate and the slot of the fixer possesses the structural and electrical connections so as to make the membrane electrode assembly of the fuel cell of the substrate output electrical power and conduct the control signals to the circuit board.

### BRIEF DESCRIPTION OF THE DRAWINGS

The above objective and advantages of the present invention will become more apparent with reference to the appended drawings wherein:

FIG. 1 shows the elevational decomposition figure of the first embodiment of the card-insertion type of fuel cell apparatus of the present invention;

FIG. 2 shows the elevational composition figure of the present invention in FIG. 1;

FIG. 3 shows the operational illustration of the first embodiment of the card-insertion type of fuel cell apparatus of the present invention;

FIG. 4 shows the side view of the second embodiment of the card-insertion type of fuel cell apparatus of the present invention;

FIG. 5 shows the figure of the third embodiment of the card-insertion type of fuel cell apparatus of the present invention;

FIG. 6 shows the figure of the fourth embodiment of the card-insertion type of fuel cell apparatus of the present invention;

FIG. 7 shows the figure of the fifth embodiment of the card-insertion type of fuel cell apparatus of the present invention;

FIG. 8 shows the figure of the sixth embodiment of the card-insertion type of fuel cell apparatus of the present invention;

FIG. 9 shows the figure of the seventh embodiment of the card-insertion type of fuel cell apparatus of the present invention;

FIG. 10 shows the figure with another viewing angle of the fixer of the present invention FIG. 9; and

FIG. 11 shows the figure of the eighth embodiment of the card-insertion type of fuel cell apparatus of the present invention.

### DESCRIPTION OF THE INVENTION

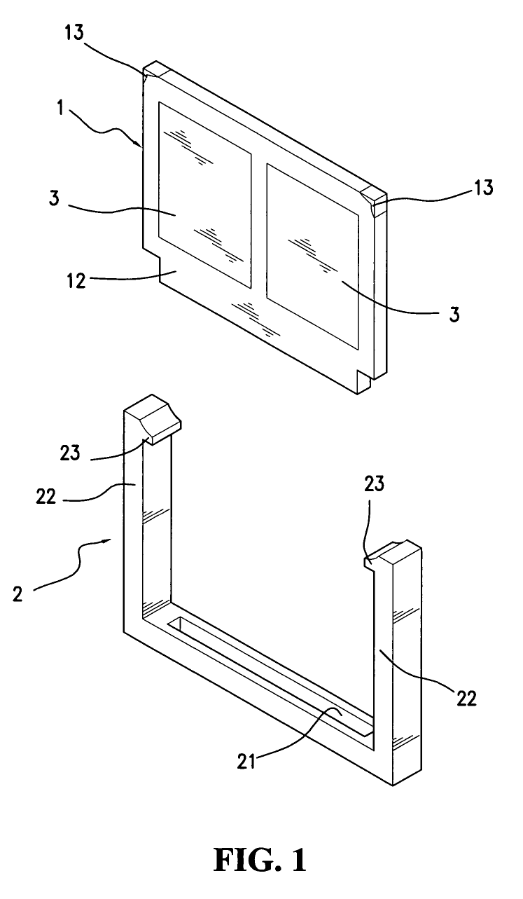

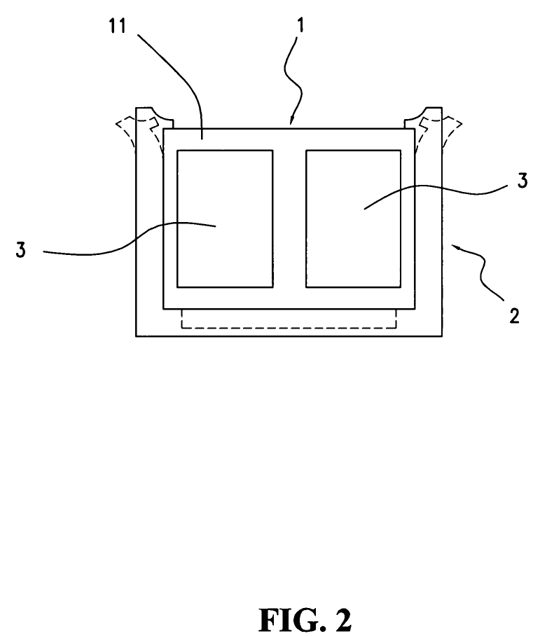

FIG. 1 shows the elevational decomposition figure of the first embodiment of the card-insertion type of fuel cell apparatus of the present invention, and FIG. 2 shows the elevational composition figure of the present invention in FIG. 1. The present invention card-insertion type of fuel cell apparatus 1 makes the fuel cell apparatus 1 fix into the fixer 2 by the structure of combining the substrate 11 and the fixer 2. The substrate 11 is a board body and is placed at least one membrane electrode assembly 3, and the bottom side of the substrate 11 is extended to form an insertion portion 12 which respectively has a first fastener 13 on the top of both sides. The fixer 2 is placed the slot 21 to fit the insertion portion 12 of the substrate 11, and the both sides of the slot 21 are extending top ward to respectively form the lock bars 22 which respectively have a second fastener 23 used to fit the first fastener 13 on both sides of the top of the substrate 11 for each lock bar 22 to fix each second fastener 23 into the corresponding first fastener 13.

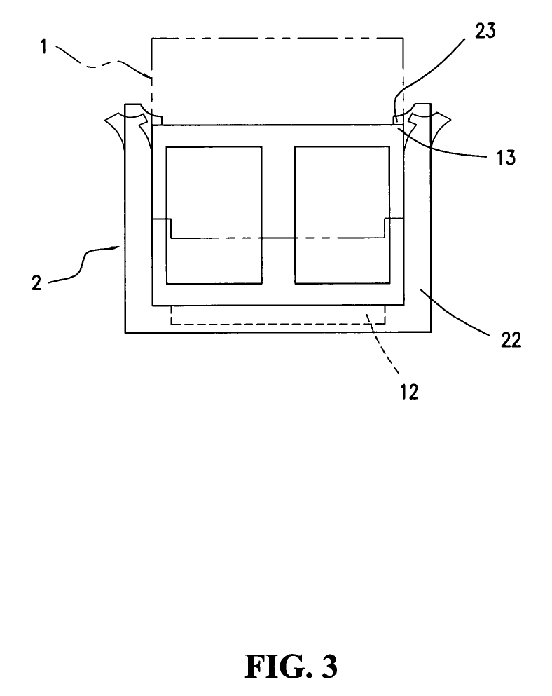

FIG. 3 shows the operational illustration of the first embodiment of the card-insertion type of fuel cell apparatus of the present invention. The lock bars 22 of the fixer 2 are quite flexible to make them on both sides expendably outward for deformation and each lock bar 22 returns back its original shape while the insertion portion 12 of the substrate 11 inserting into the slot 21 of the fixer 2 to make the second fastener 23 of the lock bars 22 fix into the corresponding first fastener 13 of the substrate 11 so as to complete the fix of the fuel cell apparatus 1. Additionally, the insertion portion 12 of the substrate 11 and the slot 21 of the fixer 2 are able to closely match for each other to enhance the combination of the substrate 11 and the fixer 2.

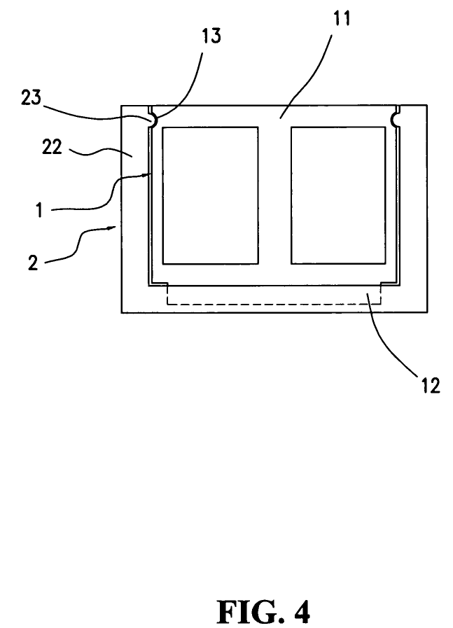

FIG. 4 shows the side view of the second embodiment of the card-insertion type of fuel cell apparatus of thee present invention. The implemented means of the first fastener 13 of the substrate 11 is to use a recess and the second fastener 23 of the lock bars 22 of the fixer 2 is implemented by a flange which matches the recess 13 so as to make the flange formed by the second fastener 23 of the lock bars 22 match the corresponding recess 13 of the substrate 11 while the insertion portion 12 of the substrate 11 inserting into the slot 21 of the fixer 2 to complete the fix of the card-insertion type of fuel cell apparatus 1.

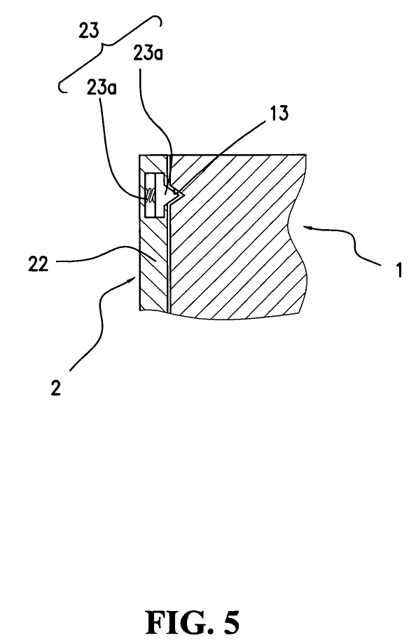

FIG. 5 shows the figure of the third embodiment of the card-insertion type of fuel cell apparatus of the present invention. The implemented means of the first fastener 13 of the substrate 11 is to use a recess and the second fastener 23 of the lock bar 22 of the fixer 2 is to use the outward protruded pawl 23a to match the recess in usage, and also the pawl 23a is built in the lock bars 22 and able to slide along side edges and the lock bar 22 is placed a spring 23b to offer the pawl 23a for the tendency of outward maintenance. Therefore, when the insertion portion 12 of the substrate 11 inserts into the slot 21 of the fixer 2, the pawl 23a of the second fastener 23 of the lock bars 22 shrinks back by the compression of the side edges of the substrate 11 and is finally affected by the bounce of the spring 23b to fix the recess 13 of the substrate 11.

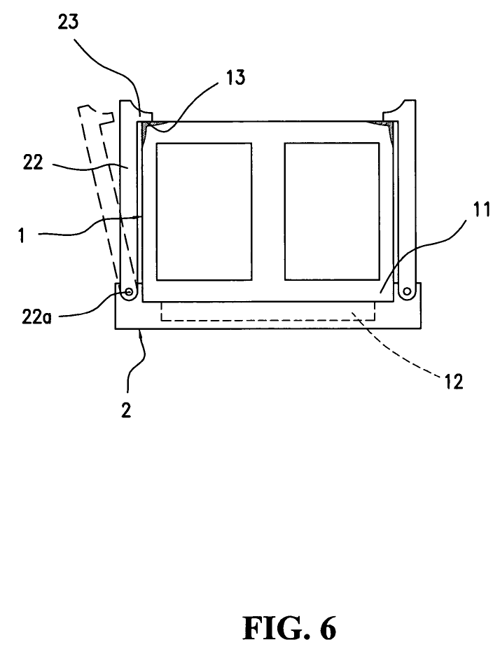

FIG. 6 shows the figure of the fourth embodiment of the card-insertion type of fuel cell apparatus of the present invention. The lock bars 22 of the fixer 2 are connected to the pivots 22a on both sides of the slot 21 of the fixer 2 to make the lock bars rotate along the pivots 22a as the axes. Furthermore, the second fastener 23 of each lock bar 22 matches the first fastener 13 on both sides of the top of the substrate 11 ,therefore to open the lock bars 22 firstly, then the insertion portion 12 of the substrate 11 inserts into the slot 21 of the fixer 2 to close each lock bar 22 back. In order to make the second fastener 23 of the lock bars 22 fix into the corresponding first fastener 13 of the substrate 11 so as to complete the fix of the card-insertion type of fuel cell apparatus 1.

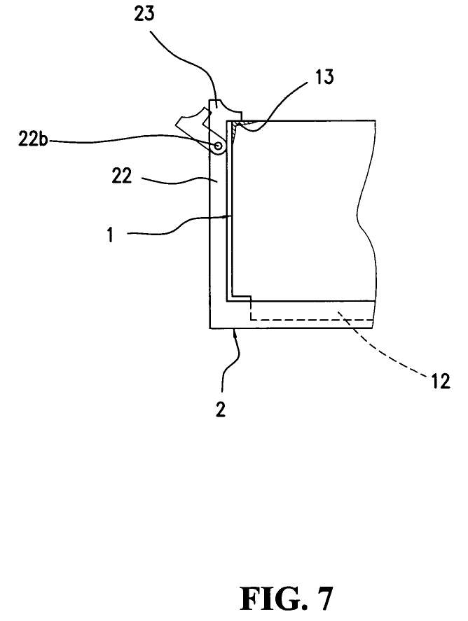

FIG. 7 shows the figure of the fifth embodiment of the card-insertion type of fuel cell apparatus of the present invention. In the fixer 2, the bottom of the second fastener 23 is connected to the pivot 22b located at the top of the lock bar 22 to make the second fastener 23 able to utilize the pivot 22b as the axis for rotation. Furthermore, the second fastener 23 of each lock bar 22 matches the first fastener 13 on both sides of the top of the substrate 11, and therefore opening the head of each lock bars 22 in first, and then the insertion portion 12 of the substrate 11 inserts into the slot 21 of the fixer 2 to close each lock bar 22 back in order to make the second fastener 23 of the lock bars 22 fixed into the corresponding first fastener 13 of the substrate 11 so as to complete the fix of the card-insertion type of fuel cell apparatus 1.

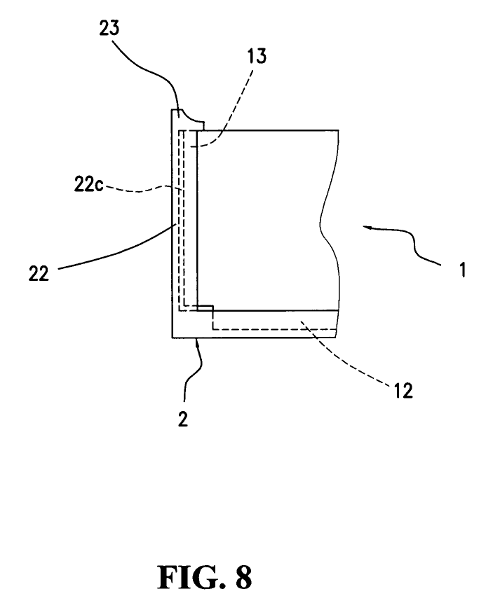

FIG. 8 shows the figure of the sixth embodiment of the card-insertion type of fuel cell apparatus of the present invention. In the fixer 2, the interiors of two lock bars 22 concave ward form the direct trough 22c to match the side edges of the substrate 11, respectively and the second fastener 23 of each lock bar 22 matches the first fastener 13 on both sides of the top of the substrate 11. Therefore, the substrate 11 is along the trough 22c of the lock bars 22 to make the second fastener 23 of each lock bar 22 fitted into the corresponding first fastener 13 after the insertion portion 12 inserting into the slot 21 of the fixer 2, and each lock bar 22 is able to be fixed into the substrate 11 on the side edges to therefore more securely fixed into the fixer 2.

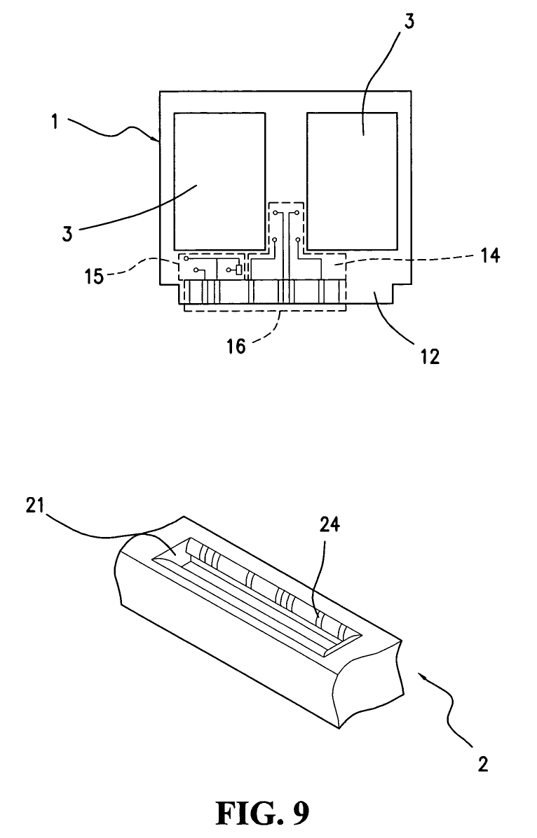

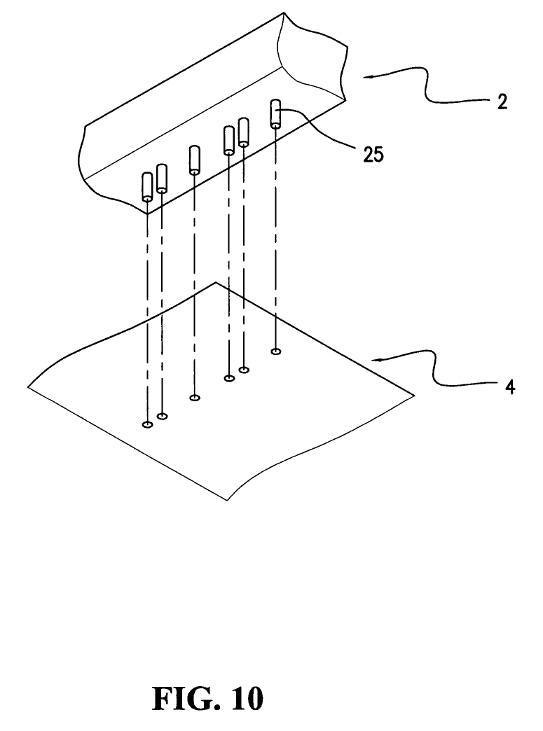

FIG. 9 shows the figure of the seventh embodiment of the card-insertion type of fuel cell apparatus of the present invention and FIG. 10 shows the figure with another viewing angle of the fixer of the present invention in FIG. 9. The substrate 11 has power conducting circuit 14 to output the electrical power generated by the membrane electrode assemblies 3, and the substrate 11 has also the control circuit 15 to control the operation of the membrane electrode assemblies 3 or provide the conduction of electrical signals. The insertion portion 12 of the substrate 11 forms the first electrical I/O port 16 to connect the power conducting circuit 14 and the control circuit 15 used for the conducting interface of the power conducting circuit 14 and the control circuit 15. Furthermore, in the slot 21 of the fixer 2, the second electrical I/O port 24 matches and corresponds to the first electrical I/O port 16 of the insertion portion 12 of the substrate 11, and also the second electrical I/O port 24 respectively extends to the outside of the fixer 2 to form the corresponding leads 25 used to provide the second electrical I/O port 24 electrically connecting to the circuit board 4 so as to make the first electrical I/O port 16 and the corresponding second electrical I/O port 24 form an electrical contact and then the electrical connection to the circuit board 24 by each lead 25 while the insertion portion 12 of the substrate 11 inserting into the slot 21 of the fixer 2.

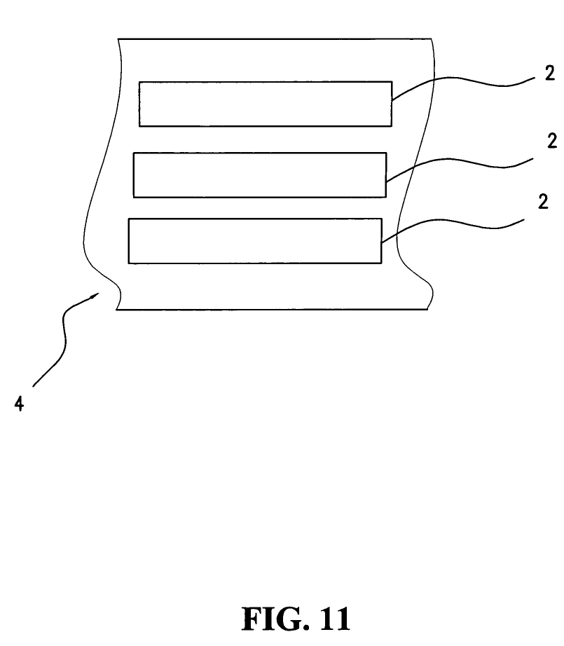

FIG. 11 shows the figure of the eighth embodiment of the card-insertion type of fuel cell apparatus of the present invention. By way of soldering the leads 25 of the fixer upon the circuit board 4, when each card-insertion type of fuel cell apparatus 1 plugs into the corresponding fixer 2, the electrical power generated by each card-insertion type of fuel cell apparatus 1 outputs the specific current or voltage by electrical series or parallel connections on the circuit board 4.

The present invention card-insertion type of fuel cell apparatus 1 is implemented as the use of gas fuel of card-insertion type of fuel cell apparatus or the use of liquid fuel of card-insertion type of fuel cell apparatus.

Although the present invention has been disclosed one embodiment as the above, it does not imply to limit the present invention, any person who is skilled the art could make any change or modification within the spirit and scope of the present invention, however, it belongs to the scope of the present invention, the protective scope of the present invention is defined by the following claims.

What is claimed is:

1. A card-insertion type of fuel cell apparatus, comprising:
a substrate, which is placed at least one membrane electrode assembly;
an insertion portion, which is placed on the bottom of the substrate;
a first fastener, which is placed on the substrate;
wherein the insertion portion and the first fastener match a fixer to make the card-insertion type of fuel cell apparatus fix into the fixer.

2. The card-insertion type of fuel cell apparatus according to claim 1, further comprising:
the fixer, which has a slot to match the insertion portion of the substrate and respectively forms lock bars by extending upward from both side edges of the slot, each lock bar respectively has a second fastener used to match the first fastener and makes each second fastener fixed into the corresponding first fastener; wherein the lock bar of the fixer is so flexible as to match the combination of the substrate and the fixer.

3. The card-insertion type of fuel cell apparatus according to claim 2, wherein the first fastener is a recess; and the second fastener is a flange which matches the recess.

4. The card-insertion type of fuel cell apparatus according to claim 2, wherein the first fastener is a recess; and the second fastener has a pawl and a spring used to match the second fastener and also the pawl is built in the lock bar to slide along side ways and then maintains the outward tendency by the spring.

5. The card-insertion type of fuel cell apparatus according to claim 2, wherein the lock bars is connected to the pivot on both sides of the slot of the fixer to rotate along the pivot as the axis.

6. The card-insertion type of fuel cell apparatus according to claim 2, wherein the second fastener is connected to the pivot of the top of the lock bars to rotate along the pivot as the axis.

7. The card-insertion type of fuel cell apparatus according to claim 2, wherein there forms concave ward the direct trough inside the lock bars to match and guide the substrate to insert into the fixer along the trough.

8. The card-insertion type of fuel cell apparatus according to claim 7, wherein the lock bars are able to fix into the side edges of the substrate.

9. The card-insertion type of fuel cell apparatus according to claim 2, wherein the substrate is further placed a power conducting circuit, which outputs the electrical power generated by the membrane electrode assembly; and the insertion portion is in advance placed a first electrical I/O port, which is used to be the conducting interface of the power conducting circuit; and the slot is in advance placed a second electrical I/O port, which matches and corresponds to the first electrical I/O port and also the leads of the second electrical I/O port extends to the outside of the fixer to electrically connect to a circuit board.

10. The card-insertion type of fuel cell apparatus according to claim 9, wherein the leads are used to solder upon the circuit board.

11. The card-insertion type of fuel cell apparatus according to claim 1, further comprising a first electrical I/O port which is placed on the insertion portion.

12. The card-insertion type of fuel cell apparatus according to claim 11, wherein the fixer is in advance placed a second electrical I/O port, which is connected to the first electrical I/O port to form an electrical connection.

13. The card-insertion type of fuel cell apparatus according to claim 12, wherein the electrical power generated by the membrane electrode assemblies is able to supply the electrical power by the second electrical I/O port.
